(19) United States
(12) Patent Application Publication
(10) Pub. No.: US 2026/0037669 A1
(43) Pub. Date: Feb. 5, 2026

(54) PERSONAL INFORMATION DE-IDENTIFICATION PROCESSING AND ANALYSIS SYSTEM

(71) Applicant: THEGPC Inc., Gyeonggi-do (KR)

(72) Inventor: Ki Chan SUNG, Gyeonggi-do (KR)

(73) Assignee: THEGPC Inc., Gyeonggi-do (KR)

(21) Appl. No.: 19/288,194

(22) Filed: Aug. 1, 2025

(30) Foreign Application Priority Data
Aug. 2, 2024 (KR) 10-2024-0102848

(51) Int. Cl. G06F 21/62

(52) U.S. Cl. CPC G06F 21/6254

(57) ABSTRACT

A personal information de-identification processing and analysis system for analyzing sensor data including personal information after performing de-identification processing on the sensor data is provided. To this end, the personal information de-identification processing and analysis system includes a sensor module configured to collect at least two pieces of sensor data, a vector conversion module configured to convert the sensor data collected by the sensor module into vector data, a vector DB configured to store the vector data, a vector search module configured to search the vector DB for vector data most similar to the vector data converted by the vector conversion module, and an output module configured to output the searched vector data.

### CROSS REFERENCE TO RELATED APPLICATION

The present application claims priority to Korean Patent Application No. 10-2024-0102848, filed Aug. 2, 2024, the entire contents of which are incorporated herein for all purposes by this reference.

### TECHNICAL FIELD

The present disclosure relates to a personal information de-identification processing and analysis system, and more particularly, to a system for analyzing sensor data including personal information after performing de-identification processing on the sensor data.

### BACKGROUND

Modern devices typically operate by integrating various types of sensor information. Since it is difficult to understand complex situations by using data from a single sensor, data collected from multiple sensors are integrated and analyzed to determine the state of a user. For example, in a single-person household, various sensors such as electricity usage sensors, audio sensors, thermal sensors, and door sensors are attached to integrate various types of information and analyze the state of a user so as to activate a solitary death prevention system.

In such a system, there exists a risk of personal information being exposed during the processes of collecting, training on, and analyzing data from various sensors. Diverse data collected in everyday life should be regarded as personal information and handled with caution, and because sensitive information may be collected, more care is needed. In a system in which information collection and analysis and the risk of handling personal information coexist, a method is needed to maintain the effectiveness of information collection while reducing the risk of personal information.

### BRIEF SUMMARY

Accordingly, the present disclosure has been made keeping in mind the above problems occurring in the related art, and an objective of the present disclosure is to propose a method for de-identifying sensor data including personal information collected by an integrated sensor module.

Another objective of the present disclosure is to propose a method for performing de-identification processing differently depending on the modality of collected sensor data.

Another objective of the present disclosure is to propose a method for performing de-identification processing by considering the environment, time, and location in which sensor data is collected.

Another objective of the present disclosure is to propose a method for promptly processing collected sensor data.

In order to achieve the objectives of the present disclosure, a personal information de-identification processing and analysis system may include a sensor module including a set of sensors and configured to collect at least two pieces of sensor data from the set of sensors, a vector database (DB) configured to store vector data, a processor configured to convert the sensor data collected by the set of sensors into the vector data, and search the vector DB for vector data most similar to the vector data converted by the vector conversion module, and an output port configured to output the searched vector data.

The processor may be configured to visually represent a relationship between the at least two pieces of sensor data collected by the sensor module, wherein a point of the sensor data including location or time at which the sensor data was collected is represented as a node, and the relationship between the sensor data, which includes a temporal relationship or a causal relationship, is represented as an edge.

The processor may be configured to train a learning model by reflecting the added vector data, and to modify model parameters included in the learning model when the vector data is added.

The processor may be configured to receive the sensor data from the sensor module, and The processor may be configured to modify the model parameters according to the added vector data, and transmit the modified model parameters to a central server.

The central server may be configured to integrate model parameters provided from at least two devices, and distribute the integrated model parameters to the devices.

The processor may be configured to convert context information, which includes time, location, and environment of the sensor data collected by the sensor module, together with the sensor data, into the vector data.

The processor may be configured to convert the collected sensor data into the vector data in different ways depending on a type of the collected sensor data, and combine at least two of the converted vector data into a single piece of vector data.

The personal information de-identification processing and analysis system according to the present disclosure de-identifies sensor data including personal information into vector data or the like, thereby reducing the risk of personal information being exposed.

That is, various types of personal information collected in daily life must be handled carefully, and the system of the present disclosure de-identifies the collected personal information, thereby reducing the risk of personal information exposure.

In addition, the personal information de-identification processing and analysis system according to the present disclosure integrates and analyzes at least two sensor data, thereby significantly improving the accuracy of data analysis, and furthermore, de-identifies the sensor data in consideration of the environment, time, and location in which the sensor data were collected, thereby further enhancing the accuracy of analysis.

### BRIEF DESCRIPTION OF THE DRAWING

The above and other objectives, features, and other advantages of the present disclosure will be more clearly understood from the following detailed description when taken in conjunction with the accompanying drawing, in which:

FIG. 1 illustrates an exemplary configuration of a personal information de-identification processing and analysis system according to an embodiment of the present disclosure.

### DETAILED DESCRIPTION

The aforementioned and additional aspects of the present disclosure will become more apparent through preferred embodiments described with reference to the accompanying drawing. Hereinafter, these embodiments of the present disclosure will be described in detail so that those skilled in the art can easily understand and reproduce them.

The present disclosure proposes a method of utilizing a vector DB and a knowledge graph to learn and analyze various information collected in an integrated sensor environment. The personal information de-identification processing system proposed in the present disclosure is a system capable of a similarity search that protects personal information by de-identifying the collected data without identifying individuals.

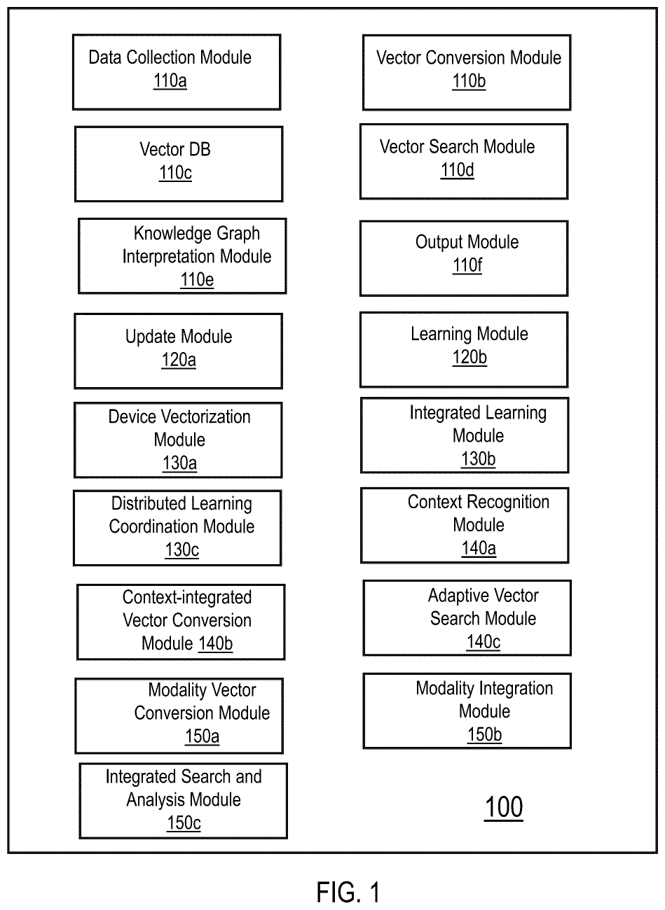

FIG. 1 illustrates an exemplary configuration of a personal information de-identification processing and analysis system according to an embodiment of the present disclosure. Hereinafter, with reference to FIG. 1, the configuration of the personal information de-identification processing and analysis system according to the embodiment of the present disclosure will be described in detail.

According to FIG. 1, the personal information de-identification processing and analysis system 100 may include a data collection module (sensor module) 110a, a vector conversion module 110b, a vector database (DB) 110c, a vector search module 110d, a knowledge graph interpretation module 110e, and an output module (port) 110f. The vector conversion module is embedded in a device to be described later, and the vector DB, the vector search module, and the knowledge graph interpretation module are embedded in a central server.

The data collection module 110a may be composed of at least two sensors and collects various sensor data. For example, the data collection module 110a may include an audio sensor, a motion detection sensor, and a power sensor.

The vector conversion module 110b may convert sensor data collected by the data collection module 110a into vector data. The data collection module 110a provides the collected sensor data to the vector conversion module. The method of converting sensor data into vector data uses an embedding technique that reflects the characteristics of each sensor data. For example, audio data is converted into vector data by extracting features such as Mel-Frequency Cepstral Coefficients (MFCC), and motion detection data is converted into vector data by extracting features of time series data. These feature extraction methods utilize embedding techniques learned through machine learning models to convert sensor data into high-dimensional vector data.

To describe this again, first, the data collection module 110a may collect sensor data, and, as described above, the sensor data includes audio data, motion detection data, power data, and the like.

The collected sensor data undergoes a preprocessing process. The preprocessing process removes noise from the collected sensor data and performs processing such as normalization. Features according to each sensor type are extracted from the sensor data that has undergone the preprocessing process. For example, audio data is processed to extract Mel-Frequency Cepstral Coefficients (MFCC). Motion detection data is processed to extract time series features through time series analysis. Power data is processed to extract features through usage or frequency analysis.

The extracted features are converted into vector data in vector format, and the converted vector data is stored in the vector DB 110c.

The vector DB 110c may store vector data learned in a specific domain. The vector DB 110c stores high-dimensional vector data extracted through a machine learning model, such as image, text, and audio.

The vector search module 110d may search for a vector most similar to the vector data converted by the vector conversion module from the vector DB 110c. The vector search module 110d searches for images similar to a specific image and data similar to specific data through the similarity search of vector data. In the similarity search, various similarity search methods such as cosine similarity and Euclidean distance are supported, and similar items can be quickly searched for even in complex high-dimensional spaces. For example, the system of the present disclosure utilizes an approximate nearest neighbor (ANN) search algorithm to search for similar vector data from a large amount of vector data.

The knowledge graph interpretation module 110e may interpret vector data on the basis of a specific scenario. For example, if a scenario such as “If a sound like ‘ak’ is detected by an audio sensor, and no motion is detected by an motion sensor for a predetermined period of time thereafter, it may be estimated as a fall,” is defined, the knowledge graph interpretation module receives vector data searched by the vector search module and interprets the vector data on the basis of the defined scenario.

The knowledge graph defines relationships between vector data and provides more accurate context, thereby improving the accuracy of vector data interpretation. The scenario defines a specific situation based on these relationships.

The knowledge graph visually represents relationships between sensor data and allows sensor data to be understood more clearly. Each point of sensor data is represented as a node, and the relationships between sensor data are represented as edges.

The scenario defines rules or patterns for interpreting the meaning of sensor data on the basis of a specific situation or event, and as a part of the knowledge graph, explains how the sensor data interacts under specific conditions or situations.

The knowledge graph includes all relationships necessary to interpret sensor data, including the scenario. The scenario as a part of the knowledge graph is used to describe a specific situation, wherein the knowledge graph encompasses a broader range of sensor data interactions.

To describe this specifically, an example of a solitary death prevention system is as follows.

The components of the knowledge graph are divided into nodes, which represent each sensor data point (audio sensor data, motion sensor data, time, location), and edges, which represent relationships between data (temporal order, causality, and an association).

The scenario is estimated as a fall if a sound like “ak” is detected by the audio sensor and no motion is detected by the motion sensor for a predetermined period of time.

In the case of the above-mentioned edges, the “ak” sound represents time (the time point of occurrence), the “ak” sound and the motion sensor indicate an association, and the time and the motion sensor indicate a temporal relationship.

The audio sensor data and the motion sensor data are associated around time T0, and if no movement is detected in the motion sensor data after time T0, it is estimated as a fall in connection with the occurrence of the “ak” sound in the audio sensor data. In addition, if the location is a living room, the reliability of the fall estimation may be increased.

The knowledge graph defines relationships between data and provides more accurate context, thereby improving the accuracy of data interpretation.

The output module (port) 110f receives results interpreted by the knowledge graph interpretation module and provides the results to a user terminal or a required system. The output module 110f receives not only the interpretation results from the knowledge graph interpretation module but also the search results from the vector search module and outputs the results.

As an example, a fall estimation scenario is performed as follows.

Audio sensor data or motion sensor data is collected, and among the collected data, a sound “ak” from the audio sensor data is converted into vector data, and the motion sensor data is also converted into vector data.

Similarity search is performed on the converted vector data, and through the similarity search, the most similar vector data is searched from the vector DB.

Afterwards, the searched vector data is matched with a knowledge graph scenario to determine whether a fall has occurred, and a final result called “fall estimation” is delivered to the system.

As described above, the system of the present disclosure combines the vector DB and the knowledge graph to enable the reliable analysis of sensor data while protecting personal information, and has the advantage of being applicable to various scenarios.

Hereinafter, a sensor data matching process using the vector DB will be described in detail.

1. A personal information de-identification processing and analysis system with dynamic learning and updating functions.

Conventional vector DBs perform search and analysis on the basis of a fixed dataset. However, sensor data continuously changes in real time, requiring the system to learn new patterns.

The personal information de-identification processing and analysis system is a dynamic learning system that collects sensor data in real time, continuously updates the vector DB with the collected data, and performs learning. Furthermore, the system vectorizes new data in real time and integrates it with the existing vector DB to continuously update the dataset, thereby improving the accuracy of data analysis.

In another embodiment, the personal information de-identification processing and analysis system 100 may further include an update module 120a, and a learning module 120b.

In this embodiment, the data collection module 110a may collect sensor data in real time. That is, the data collection module 110a collects real-time sensor data from a plurality of sensors.

The vector conversion module 110b may convert the collected sensor data into vector data in real time.

The update module 120a may add and update the converted vector data to the vector DB in real time. Specifically, the update module 120a may synchronize with the existing vector DB in real time.

The learning module 120b may continuously train a learning model by reflecting the added vector data. The learning model incrementally updates itself by reflecting the new vector data. To this end, the learning model uses an online learning algorithm and adjusts its model parameters each time new vector data is added. For example, the learning model is updated by using Stochastic Gradient Descent (SGD), and learning performance thereof is evaluated in real time. The details are as follows.

Sensor data is collected in real time from various sensor modules. As described above, the sensors include an audio sensor, a motion detection sensor, a power sensor, and the like. The collected sensor data undergoes preprocessing processes such as noise removal and normalization, and then is converted into vector data and stored in the vector DB.

The vector database (DB) 110c selects data necessary for training and prepares the data so that the model can be trained by using both existing data and new data together. In this process, model parameters are adjusted by considering the use of new data, and the new model parameters are updated from the existing model parameters through backpropagation using the new data (for example, updating the parameters by using stochastic gradient descent).

Backpropagation is one of the main algorithms used for training an artificial neural network. It calculates an error between predicted values of the neural network and actual values, then propagates this error backward through each layer of the neural network to adjust weights. Through this process, parameters are updated so that the model can perform more accurate predictions.

Afterwards, the updated model is evaluated by using validation data, and the model that passes validation is deployed and applied to real-time services.

The process of backpropagation of an error proceeds as follows.

1. Forward propagation: Input data is passed through each layer of the network to compute an output value.

2. Error calculation: Difference between an output value and an actual value is calculated, and this difference is called an error.

3. Backpropagation of an error: An error at an output layer is calculated. For example, when the loss function is mean squared error (MSE), the error is computed as (a predicted value−an actual value).

The error computed at the output layer is propagated to the previous layer in order to calculate the error of the hidden layer. In this case, each weight is modified during the error propagation.

4. Weight update: the weight is adjusted on the basis of the calculated error. In this case, the gradient descent algorithm is used to update the weight.

Stochastic Gradient Descent (SGD) is a variant of gradient descent which updates weights for randomly selected or a small number of data points instead of the entire dataset at each training step. This increases training speed and allows efficient learning even when the dataset is very large.

To elaborate, the personal information de-identification processing and analysis system provided in the present disclosure collects sensor data in real time, may convert the collected sensor data into vector data, and updates the vector DB with the converted vector data in real time. Then, by using the updated vector DB, the system may continuously train the learning model and, if necessary, outputs training results.

2. A integrated learning-based personal information de-identification processing and analysis system for privacy protection

Sensor data collected by the sensor module may be processed separately on each device, but transmitting this data to the central server may raise privacy issues.

The system of the present disclosure utilizes integrated learning to perform the vectorization of sensor data on individual devices, and transmits only vector data to the central server to perform training and analysis. The central server performs comprehensive analysis without collecting original sensor data from the individual devices.

Integrated Learning is a method in which local models are trained on individual devices, and then model parameters (weights) are transmitted to the central server to update an integrated model centrally. Therefore, compared to general learning that gathers all data in the central server for training, the integrated learning performs training within each device without transmitting original data to the central server, thereby protecting personal information. The central server integrates local model parameters to update the global model, which is then distributed back to each device.

As described above, the integrated learning proceeds as follows: without transmitting sensor data to the central server, a local model is trained on each device, and the central server integrates model parameters to update the global model.

1. Local training: Each device trains a local model by using sensor data.

2. Model parameter transmission: Model parameters trained by each device are transmitted to the central server.

3. Model parameter integration: The central server integrates the model parameters of each device to update the global model.

4. Model distribution: The updated model is distributed to each device.

Sensor data collected from sensors is transmitted to individual devices, and in the individual devices, the sensor data is converted into vector data and then sent to the central server. In the integrated learning model, the sensors (the sensor module) and devices each perform unique roles.

While the sensor module collects various forms of sensor data, the device receives the sensor data collected from the sensor module and processes and converts the sensor data. To this end, each device has computing capabilities to perform data processing independently.

In another embodiment, the personal information de-identification processing and analysis system 100 may include a device vectorization module 130a, an integrated learning module 130b, and a distributed learning coordination module 130c.

The device vectorization module 130a may convert sensor data from each device into vector data. The converted vector data may be stored in the device locally or in a remote storage.

The integrated learning module 130b may integrate vector data transmitted from individual devices into the central server and performs learning and analysis. The integrated learning module 130b integrates the vector data transmitted from each of the devices and performs learning by using the integrated vector data.

The distributed learning coordination module 130c may coordinate learning or performs updates between the devices and the central server. The updated learning model is distributed to each of the devices.

To elaborate, the personal information de-identification processing and analysis system 100 provided in the present disclosure may perform vectorization of sensor data from each device and transmit the resulting vector data to the central server. The central server may integrate vector data transmitted from each device, performs training on the integrated vector data, and distribute the resulting learning model to each device.

3. A context-based adaptive personal information de-identification processing and analysis system

Even the same sensor data may be interpreted differently depending on the situation or environment. For example, day and night environments, indoor and outdoor conditions, etc. may affect the analysis results.

The personal information de-identification processing and analysis system 100 according to the present disclosure may adaptively perform vector searches by considering the context of sensor data (e.g. a time, location, environment, etc.), include context information in vector data, and perform searches based on similarity that fits the context during search, thereby enabling more accurate searches.

In another embodiment, the personal information de-identification processing and analysis system 100 may include a context recognition module 140a, a context-integrated vector conversion module 140b, and an adaptive vector search module 140c.

The context recognition module 140a may collect context information about sensor data. That is, the context recognition module 140a collects context information such as time, location, and environment, and converts the collected context information into data.

The context-integrated vector conversion module 140b may integrate sensor data and context information and converts them into vector data. That is, the context-integrated vector conversion module 140b integrates sensor data and context information, converts them into vector data, and stores or manages the converted vector data.

The adaptive vector search module 140c may perform similarity searches on context information on the basis of vector data. That is, the adaptive vector search module 140c reflects the search results in the context.

The similarity determination of context differs from the similarity determination of sensor data. The similarity of sensor data is determined on the basis of numerical similarity of vector data (e.g., cosine similarity, Euclidean distance, etc.), whereas the similarity of context is determined by considering contextual factors such as time, location, and environment. The final similarity is determined by comprehensively considering the two similarities.

For example, in the case of a solitary death prevention system, the following situations may be distinguished.

Situation 1 involves a sound of “ak” detected by an audio sensor at 10 PM in the living room, followed by no motion detected by the motion sensor for 5 minutes. Situation 2 involves a sound of “Help me” detected by an audio sensor at 11 PM in the bedroom, followed by no motion detected by the motion sensor for 3 minutes. In this regard, the similarity determination process is as follows.

The similarity of audio sensor data is determined by comparing the MFCC features of the “ak” sound and the “Help me” sound. For example, the MFCC features of the two sounds have a similarity of 0.8 (a range of 0 to 1).

The similarity of motion sensor data is determined by comparing movement patterns in the two situations. For example, the similarity of the no-movement pattern is 0.9.

In context similarity, a similarity between 10 PM and 11 PM (small time difference) is set to 0.95, and a similarity between locations, the living room and bedroom, is set to 0.7 (different rooms) by considering the difference of the locations, and a similarity between the environments is set to 1.0 (same environmental conditions) by considering that they are the same indoor environments.

The final similarity is determined as follows: The sensor data similarity is calculated as (audio similarity 0.8+motion similarity 0.9)/2=0.85.

The context similarity is calculated as (time similarity 0.95+location similarity 0.7+environment similarity 1.0)/3=0.88. Therefore, the final similarity is calculated as (sensor data similarity 0.85+context similarity 0.88)/2=0.865.

The system of the present disclosure collects context information together with sensor data at the time of collection. The collected sensor data and context information are then integrated and converted into vector data. Subsequently, similarity search is performed on the basis of the converted vector data and the vector data stored in the vector DB, and the results of the search are analyzed.

4. A personal information de-identification processing and analysis system with multi-modality data integration

Sensor data exists in various modalities (e.g., image, text, audio, etc.), and it is important to integrate and analyze them. The present disclosure provides a system that integrates various modality data and processes it in a single vector DB. The system converts each modality data into vector data, and integrates the vector data to perform search and analysis.

The method for converting data into vector form varies depending on the modality. For example, images are converted into vectors by extracting features by using a Convolutional Neural Network (CNN), text is converted into vectors by using an embedding technique such as Word2Vec or BERT, and audio is converted into vectors by extracting features such as Mel-Frequency Cepstral Coefficients (MFCC). Motion detection data may be processed by LSTM to extract features and convert them into vectors. That is, values or factors referenced during vector conversion may vary depending on modality, thereby allowing the characteristics of each modality to be effectively converted into vectors.

In another embodiment, the personal information de-identification processing and analysis system 100 may further include a modality vector conversion module 150a, a modality integration module 150b, and an integrated search and analysis module 150c.

The modality vector conversion module 150a may convert data of each of a plurality of modalities into vector data. The modality vector conversion module 150a converts the data according to each of the plural modalities, such as image, text, and audio, and manages the converted modality vector data.

Integrating modality vector data means combining various different types of data into a single consistent vector representation. Since each modality has different characteristics and structures, the process of integrating them into one vector is very important. This is necessary to analyze various data together and to obtain more accurate and rich information.

The process of integrating modality vector data is as follows.

1. Individual modality vector conversion

Each modality data (audio data, image data, text data, motion detection data) is individually converted into a vector.

2. Vector normalization

Each modality vector is normalized to the same scale, which is necessary for comparing and combining different modality vectors.

3. Vector combination

The normalized modality vectors are combined into a single integrated vector. Combination methods include vector concatenation, averaging, and weighted averaging.

4. Integrated vector generation

The combined vector is generated as a final integrated vector. This vector includes information from multiple modalities and allows integrated analysis of multimodal data.

The modality integration module 150b integrates converted vector data and constructs a single vector data DB. The modality integration module 150b integrates various modality vector data and stores and searches the integrated modality vector data.

The integrated search and analysis module 150c performs search and analysis on the basis of the integrated vector data. The integrated search and analysis module 150c searches for similarities between the integrated vector data and the vector data stored in the vector DB, and provides an integrated analysis result.

The similarity determination of the integrated vector data is performed by comprehensively considering the characteristics of each modality data. For example, after converting image data and text data into vectors respectively, these vectors are combined into a single high-dimensional vector. Similarity is determined on the basis of the combined vector, and for this, a technique that evaluates the characteristics of multiple modalities in an integrated manner is used.

The similarity determination of the integrated vector data is performed by combining data from multiple modalities into a single vector and determining similarity on the basis of that vector. By using the integrated vector, it is possible to comprehensively consider the information of each modality, thereby enabling more sophisticated analysis. However, there are concerns that the integrated vector may reduce accuracy, and to address this, several technical approaches may be used to find valid matching values.

As a problem-solving approach, there is a method of assigning weights to individual modalities. Weights are assigned by reflecting the importance of each modality, and an integrated vector is generated on the basis of this. This is useful when a specific modality plays a more important role in an overall analysis.

In the system of the present disclosure, various modality data are collected and each of the modality data is converted into vector data. Then, similarity search and analysis are performed on the basis of integrated vector data obtained by integrating the converted vector data, and the results of the execution are provided to the system.

Each component constituting the personal information de-identification processing and analysis system shown in FIG. 1 described above may be included in a single personal information de-identification processing and analysis system and perform the corresponding operation.

The present disclosure has been described with reference to an embodiment shown in the drawing, but this is merely exemplary, and it will be understood by those skilled in the art that various modifications and equivalent other embodiments may be derived therefrom.

As used in this application, the terms “module” and “system” are generally intended to refer to a computer-related entity, either hardware, a combination of hardware and software, software, or software in execution. For example, one or more of the vector conversion module 110b, the vector database (DB) 110c, the vector search module 110d, the knowledge graph interpretation module 110e, the update module 120a, the learning module 120b, the device vectorization module 130a, an integrated learning module 130b, the distributed learning coordination module 130c, the context recognition module 140a, the context-integrated vector conversion module 140b, the adaptive vector search module 140c, the modality vector conversion module 150a, the modality integration module 150b, and the integrated search and analysis module 150c may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

What is claimed is:

1. A personal information de-identification processing and analysis system comprising:
a sensor module including a set of sensors and configured to collect at least two pieces of sensor data from the set of sensors;
a vector database (DB) configured to store vector data;
a processor configured to:
convert the sensor data collected by the set of sensors into the vector data; and
search the vector DB for vector data most similar to the vector data converted by the vector conversion module; and
an output port configured to output the searched vector data.

2. The system of claim 1, wherein
the processor is configured to visually represent a relationship between the at least two pieces of sensor data collected by the sensor module, wherein a point of the sensor data including location or time at which the sensor data was collected is represented as a node, and the relationship between the sensor data, which includes a temporal relationship or a causal relationship, is represented as an edge.

3. The system of claim 2, wherein
the processor is configured to train a learning model by reflecting the added vector data, and to modify model parameters included in the learning model when the vector data is added.

4. The system of claim 3, wherein the processor is configured to receive the sensor data from the sensor module,
wherein the processor is configured to modify the model parameters according to the added vector data, and transmit the modified model parameters to a central server.

5. The system of claim 4, wherein the central server is configured to integrate model parameters provided from at least two devices, and distribute the integrated model parameters to the devices.

6. The system of claim 1, wherein the processor is configured to convert context information, which includes time, location, and environment of the sensor data collected by the sensor module, together with the sensor data, into the vector data.

7. The system of claim 6, wherein the processor is configured to convert the collected sensor data into the vector data in different ways depending on a type of the collected sensor data, and combine at least two of the converted vector data into a single piece of vector data.
